(19) United States
(12) Patent Application Publication
(10) Pub. No.: US 2003/0001400 A1
(43) Pub. Date: Jan. 2, 2003

(54) Hand-held gardening tool

(76) Inventor: Robert A. Kelzer, Thomasville, GA (US)

Correspondence Address: Brian D. Bellamy, P.O. Box 1997, Thomasville, GA, 31799-1997, US

(21) Appl. No.: 09/896,376

(22) Filed: Jun. 28, 2001

(51) Int. Cl. A01B 1/20

(52) U.S. Cl. 294/57

(57) ABSTRACT

The present invention is a hand-held gardening tool comprising a pair structural members having a head for use as an implement in gardening activities. The head is attached to one end of the structural members and includes a cultivating claw and a blade edge. A handle to be gripped by one hand during use in gardening activities is attached between the structural members at about the midpoint of their length. An adjustable arm strap for receiving the arm of a gardener is attached between the structural members near ends opposing the head.

### TECHNICAL FIELD

The present invention relates to a hand-held gardening tool that is particularly suited for cultivating and hoeing.

### BACKGROUND OF THE INVENTION

Hand-held cultivators or cultivating claws are commonly used in loosening and preparing ground for planting. Other hand-held gardening tools having sharp blade edges, such as small hoes, are used in weeding and digging. In maintaining a garden, these hand-held gardening tools are raised by hand and then swung downward into the ground to manipulate the soil. Typically, such hand cultivators and hoes are held by the gardener wrapping their hand around a handle grip extending from an attached claw or blade portion of the tool.

Several United States design patents disclose the typical design of a hand cultivator. These include U.S. Pat. No. Des. 375,236 to Spear et al., U.S. Pat. No. Des. 295,712 to Scott, U.S. Pat. No. Des. 397,593 to Mendoza, U.S. Pat. No. Des. 349,023 to Linden et al., and U.S. Pat. No. Des. 339,039 to Concari. Each of these design patents teaches a hand-held cultivating tool consisting of a handle grip extending from an attached claw.

Many of the people who enjoy gardening are elderly or otherwise disabled by their strength, health, or ability. For such persons, using the typical hand cultivator can strain their ability to grip the handle of the device or to apply enough force to effectively use the device. For instance, arthritic persons may have a very difficult time wrapping their hand completely around the handle because of difficulty in bending their fingers or thumb. Difficulty holding the handle of the typical hand cultivator will limit the force that can be applied for harrowing, digging, and cutting weeds. The weight of the claw or blade element of the device may be increased to enhance the force applied by swinging the element with the handle of the device. However, increasing the weight of the claw or blade element also makes holding the tool while swinging it more strenuous.

Thus, there exists a need for a hand-held gardening tool for cultivating and hoeing that mitigates these disadvantages, and has a suitable structure for more effective use by persons who are generally less proficient in holding and manipulating hand tools. Particularly, a need exists for a hand cultivator that can be used without applying a tight grip to the handle and that promotes the application of greater force with less effort.

Prior art hand-held gardening tools are generally designed for a single purpose. Hand cultivators are designed having a claw, and hand-held hoes are well known to have a blade element. The handle grip extending from an attached claw or blade portion of these tools is often shaped to fit the user's hand in a specific manner. Thereby, the handle of these tools limits the directional manner in which the tool is used. Even where the handle is neutral as to the directional manner that the tool is used, the use of the tool having a solitary claw or blade element is limited by the direction of the element. Further, a gardener will frequently cultivate, dig, and chop weeds concurrently. During this process, the gardener will have to alternate between tools such as the cultivator and the hoe. The actions needed to constantly change tools such as reaching, stooping, kneeling, and standing cause additional strain on the gardener. Therefore, it is desirable to provide a gardening tool which integrates a cultivator and a hoe into a single hand tool.

Larger gardening tools such as full size hoes and rakes have a single long shaft extending from the head of the tool. The long shaft is tailored to be held by two hands while employed, and the tool is very difficult to control if held by one hand. However, there are instances in which a gardener would desire to use a gardening tool while standing up, but still only use one hand in employing the tool. For example, some persons have back troubles that limit their ability to stoop or kneel, but those same persons enjoy gardening. Physical limitations may also make it advantageous to use the tool holding it with one hand while standing up to prevent twisting of the gardener's muscles when using the tool. Therefore, a further need exists for a gardening tool that can be employed using one hand while the gardener is standing upright.

### SUMMARY OF THE INVENTION

The present invention provides a hand-held gardening tool for both cultivating and hoeing. The gardening tool includes a pair of elongated structural members that connect to a head at a first terminal end of the structural members. A handle is attached between the structural members at about the midpoint of the length of the structural members, such that the handle is parallel to the top and bottom edges of the head. An arm supporting strap is attached near the second terminal end of the structural members at the opposite end from the head. The head is dual-purpose and has a cultivating claw at the top edge and a blade for hoeing at the bottom edge. The tool may be turned 180 degrees so that the cultivating claw becomes the bottom edge of the head and the blade becomes the top edge of the head.

Ordinarily, a firm grip on the handle of a cultivator must be maintained by wrapping the fingers of the hand around the handle. In the present invention, the typical grip extending from the head of a gardening tool has been replaced by a handle that is parallel to the working edge of the tool head, and an arm supporting is provided. As the gardener uses the present invention, the hand may support the tool without completely wrapping the fingers around the handle by leveraging the hand against the handle and the arm strap when using the tool. Further, the gardener may change the operation of the tool from cultivating to hoeing or vice-versa by rotating the tool 180 degrees.

### BRIEF DESCRIPTION OF THE DRAWINGS

FIG. 1 is a perspective view illustrating an embodiment of the hand-held gardening tool according to the present invention.

FIG. 2 is a top view of the gardening tool according to the present invention.

FIG. 3 is an end view of the head of the gardening tool according to the present invention.

FIG. 4 is a side view of the gardening tool according to the present invention.

FIG. 5 is a perspective view illustrating an alternative embodiment of the hand-held gardening tool according to the present invention.

### DETAILED DESCRIPTION OF THE INVENTION

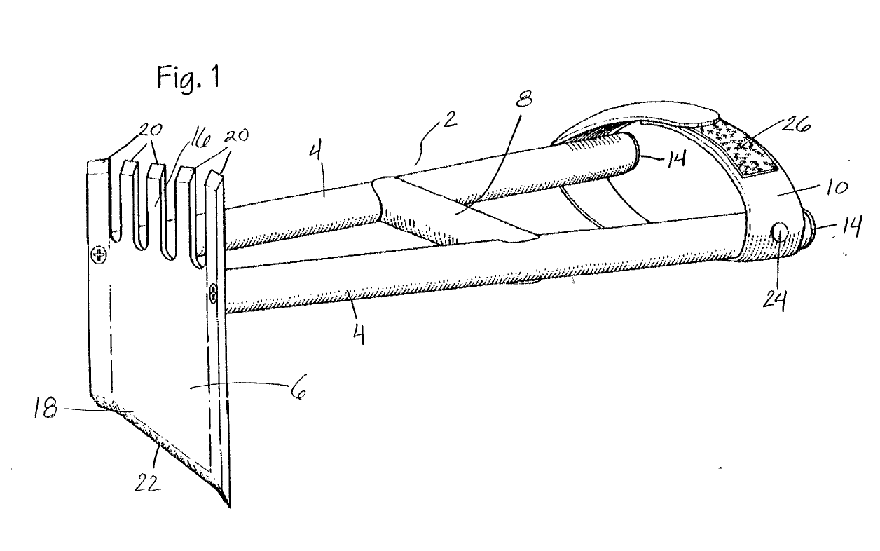

Referring to FIGS. 1 to 5, a hand-held gardening tool suitable for cultivating, hoeing, and gardening is shown. The gardening tool 2 includes a pair of rigid high strength structural members 4. The structural members support a preferred embodiment of the invention that includes a head 6, a handle 8, and an arm strap 10. The structural members as shown in the figures are constructed of hollow tubing. The structural members 4 may be constructed of tubing of plastic or metal, or it may be advantageous to construct these members 4 of solid or molded materials. The particular construction and material may change according to desired quality of tool 2.

As illustrated by the figures, the structural members 4 may be angularly disposed such that the head 6 is attached to first ends 12 of the structural members 4 where the first ends are closer together than the opposite second ends 14 of the structural members 4. The head 6 may be attached using wedge-like inserts that fit tightly into the first ends 12 where the first ends are constructed of hollow tubing. In variations of the tool 2, the head 6 may be attached by any previously known means for attaching a tool head to a shaft. For instance, the head 6 could be welded to the first ends 12, or could be bolted to the first ends 12 by providing a threaded receptacle withing the first ends 12. Preferably, the head 6 will be provided with a cultivating claw 16 or a blade edge 18 for hoeing, and the head will be attached at about its center between the claw 16 and the blade edge 18. The attachment of the head 6 to the first ends 12 is shown closer to the claw in the figures so that the blade edge 18 extends farther from structural members 4.

As shown in detail in the figures, the inventor has found that a rigid and high strength head 6 combining a cultivating claw 16 and a blade edge 18 is especially advantageous as a useful implement to be used in gardening activities. The combination head 6 is dual-purpose and is useful for cultivating and plowing dirt and also hoeing weeds and digging holes. The tool 2 may be turned 180 degrees to make the cultivating claw the bottom edge of the head and the blade the top edge of the head or vice-versa. The placement and design of the handle 8 promote the ability of the user to alternate using the claw 16 or the blade 18 by turning the tool as described.

The head 6 is constructed of metal and is flat or slightly bent. The configuration of the claw 16 and blade may vary according to the desired preferences for shape, length, and width. As shown in FIG. 3, the claw consists of five sharpened teeth 20 that are flat and evenly spaced. The blade consists of a sharpened edge 22.

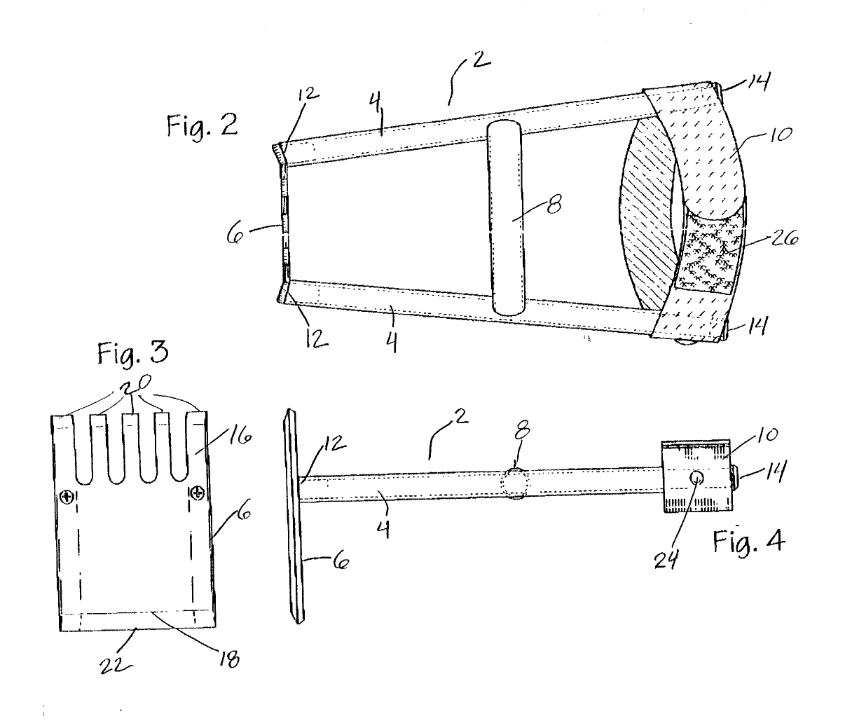

As illustrated in FIG. 2 and FIG. 4, the handle 8 attaches between the structural members 4 at about the midpoint of the length of the structural members 4. The handle 8 attaches parallel to the claw 16 and blade 18 of the head 6 to provide a sure grip for manipulating the tool 2. The gardener places either of his arms through an arm supporting strap 10 and grabs the handle 8 using his or her hand. The handle is dimensioned and configured to be comfortably held by one hand during use by a gardener. Sufficient leverage and control may be applied to the handle 8 for operating the tool 2 without the user completely tightening their fingers around the handle 8. The inventor has found that the configuration of the handle 8 is easy to use by persons with arthritis and other physical limitations.

The arm supporting strap 10 attaches near the second end 14 of the structural members 4 opposite from the first ends 12 where the head 6 attaches. The arm strap 10 is secured to the structural members 4 using rivets or screws 24. Any type of arm strap or means for securing the arm strap 10 to the structural members 4 would be suitable. Slots could be provided in the structural members 4 for receiving the strap as one such alternative means of attaching the arm strap 10 to the structural members 4.

The arm strap 10 is configured such that the gardener may comfortably place one arm through the strap 10 and grasp the handle 8 using one hand. The size of the arm strap 10 may be made adjustable by providing a fastener of velcro 26 as shown in FIGS. 1, 2, and 5 or by providing a snap buckle or other adjustable tightening means. The size of the arm strap is adjustable to have dimensions comfortable for receiving the arm of a gardener during use regardless of the size of the gardener's arm. The arm strap may be constructed of comfortable fabric, rubber, plastic, leather, or webbed material.

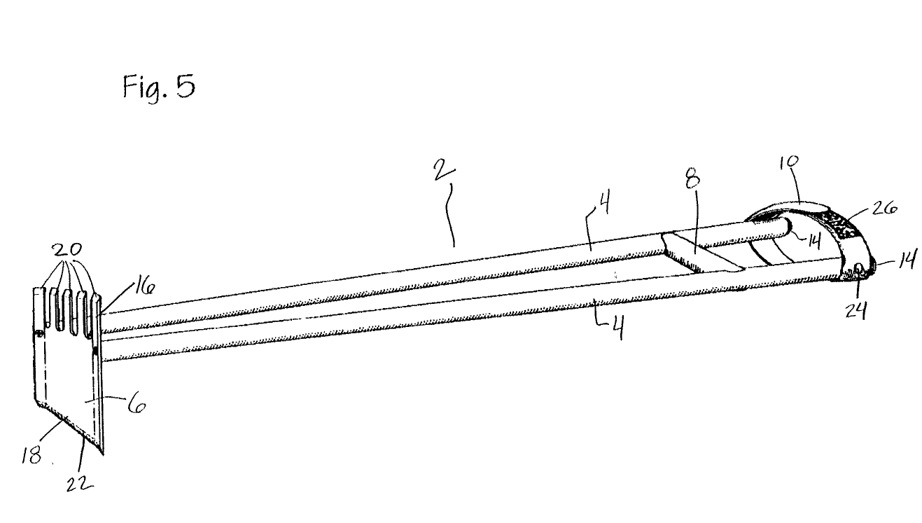

The embodiment of the gardening tool 2 shown in FIGS. 1-4 is about fifteen to twenty-one inches long and designed for use by while kneeling or squatting close to the ground. A variation of the gardening tool 2 shown is FIG. 5 is about three to five feet long and designed for use while standing. The structural members 4 in combination with the placement of the handle 8 and provision of the arm strap 10 make the gardening tool 2 disclosed herein well-adapted for use while standing. The described features provide the ability to control the claw 16 or blade 18 while holding the tool 2 with one hand. Other cultivators, hoes, and the like are designed for use by the gardener who is standing upright, but these devices provide a long shaft that requires two hands to control the device.

I claim:

1. A hand-held gardening tool comprising:
a pair of spatially separated structural members of a selected length terminating in first ends and second ends and having midpoints along their length;
a head for use as an implement in gardening activities having a cultivating claw or a blade edge attached to the first ends of the structural members;
a handle dimensioned and configured to be gripped by one hand during use in gardening activities disposed and attached between the structural members at about the midpoints of the structural members;
an arm strap dimensioned and configured to receive the arm of a gardener during gardening activities disposed and attached between the structural members near the second ends of the structural members.

2. A hand-held gardening tool as set forth in claim 1 in which said gardening tool is fifteen to twenty-one inches long.

3. A hand-held gardening tool as set forth in claim 1 in which said gardening tool is three to five feet long.

4. A hand-held gardening tool as set forth in claim 1 in which said structural members are constructed of hollow metal or plastic tubing.

5. A hand-held gardening tool as set forth in claim 1 in which said structural members are angularly disposed and said first ends are closer together than said opposing second ends of the structural members.

6. A hand-held gardening tool as set forth in claim 1 in which said head for use as an implement in gardening activities includes said cultivating claw on a first portion of the head and includes said blade edge on a second opposing portion of the head wherein said gardening tool may be rotated 180 degrees to alternate between use of the cultivating claw or the blade edge during use in gardening activities.

7. A hand-held gardening tool as set forth in claim 1 in which said arm strap adjustable to various arm sizes.
